(19) United States
(12) Patent Application Publication
(10) Pub. No.: US 2020/0334562 A1
(43) Pub. Date: Oct. 22, 2020

(54) RESERVE OPTIMIZATION METHOD AND APPARATUS BASED ON SUPPORT OUTAGE EVENT CONSTRAINED UNIT COMMITMENT

(71) Applicant: SHANDONG UNIVERSITY, Jinan, Shandong (CN)

(72) Inventors: Mingqiang WANG, Jinan (CN); Ming YANG, Jinan (CN); Xueshan HAN, Jinan (CN); Li ZHANG, Jinan (CN); Yong WANG, Jinan (CN); Mengxia WANG, Jinan (CN); Chengfu WANG, Jinan (CN); Xiaoming DONG, Jinan (CN)

(73) Assignee: SHANDONG UNIVERSITY, Jinan, Shandong (CN)

(21) Appl. No.: 16/959,908

(22) PCT Filed: Nov. 30, 2018
(86) PCT No.: PCT/CN2018/118375

§ 371 Date: Jul. 2, 2020

(30) Foreign Application Priority Data
Apr. 11, 2018 (CN) 201810321864.1

(51) Int. Cl. G06N 7/00; H02J 3/00

(52) U.S. Cl. CPC G06N 7/005; G06Q 10/067; H02J 3/001

(57) ABSTRACT

A reserve optimization method and apparatus based on a support outage event constrained unit commitment. The method includes the following steps: step 1: running a basic unit commitment reserve optimization model to obtain a basic unit commitment dispatch result; step 2: establishing a committed capacity outage probability table (CCOPT) based on the dispatch result, calculating the loss of load probability (LOLP), and identifying the marginal events therefrom; and step 3: adding linear constraints corresponding to the marginal events to the reserve optimization model to obtain a new dispatch result, and returning to step 2 till the result meets the LOLP requirements. Multiple compromises in the problem are considered, and the LOLP constraint is simplified such that the model can be accurately and efficiently solved.

### TECHNICAL FIELD

The present disclosure belongs to the field of spinning reserve optimization, and specifically relates to a reserve optimization method and apparatus based on a support outage event constrained unit commitment.

### BACKGROUND

Spinning reserve is an important resource in a power system. Spinning reserve is mainly provided by online units, and can be used in the system within a specified time, responding to power fluctuations caused by load changes in the system and component outage accidents to avoid system load shedding. The deployment of sufficient spinning reserve can reduce the loss of load possibility (LOLP) and improve the reliability of the power system. However, the deployment of spinning reserve incurs certain fees, as new generator units may be required to be scheduled, or the online units may be forced to deviate from their optimal operating points. Therefore, the spinning reserve requirements needs scientific and reasonable planning, and takes into account both the economics and reliability of the system.

Traditionally, the spinning reserve amount is determined by deterministic method, that is, the number of the spinning reserve is determined according to a certain ratio of the total load and/or the maximum online unit capacity. This method is simple and easy to implement, but easily leads to conservative or aggressive reserve deployment. Some scholars established a reserve cost model based on storage theory, and solved an optimal reserve capacity by decision theory in combination with the reserve capacity utilization probability based on historical data, thereby obtained an optimal and economical reserve capacity with desirable system reliability. Some scholars analyzed the risk of a spinning reserve scheme from the perspective of a power system, calculated the satisfactions of different types of decision makers on the cost/benefit of spinning reserve using utility function and utility values, and proposed a model to determine the spinning reserve requirement based on utility theory. Such two reserve determination schemes are more in line with economic laws, take into account the economics and reliability of the systems, and are more suitable for the power systems in the market environment. With continuous integration of new energy resources, the uncertainty in the system is gradually increasing, so that probabilistic reserve optimization methods receive more attention. The probabilistic reserve optimization methods mainly include reliability constrained optimization model, and cost/benefit optimization model. The liability constrained optimization model refers to adding a reliability index not exceeding a threshold to a dispatching model as a constraint. The cost/benefit optimization model refers to quantifying the loss caused by load shedding and then adding the loss into an objective function to minimize along with the operating cost, so that the system can be automatically balanced between economics and reliability by reserve optimization. However, when the loss of load is quantified, the value of lost load (VOLL) information is often required. This value has a significant impact on the results, and is often related to specific power systems and operating conditions, so it is difficult to obtain a reasonable VOLL. LOLP refers to the probability of user's power outage due to various disturbances in the system within a given time. This indicator directly reflects the reliability of system operation, and its concept is simple and clear, intuitive and reasonable.

The LOLP can be accurately expressed as a function of the unit on/off status, unit output power and reserve, system spinning reserve, possible events and the probability of events. The expression of the LOLP is highly non-linear and has combinatorial characteristics. It not only contains many continuous variables, but also contains a large number of 0/1 variables. The LOLP is related to not only the dispatch result but also the possible events considered. The number of the scenarios has combinatorial nature. When high-order outage events and multiple optimization periods are considered, even for smaller systems, the computer can easily run out of memory and the problems cannot be solved.

Therefore, how to ensure that the model with an LOLP constraint can be solved efficiently and can address the multiple compromises in reserve optimization model is a technical problem that need to be urgently solved by those skilled in the art.

### SUMMARY

In order to overcome the shortcomings mentioned above, the present disclosure provides a reserve optimization method and apparatus based on a support outage event constrained unit commitment, the proposed model transforms a highly non-linear and combinatorial LOLP constraint into a series of linear expressions equivalently, and considering the constraints corresponding to some of key marginal scenarios, thereby effectively improving the computation efficiency of the reserve optimization model.

In order to achieve the above objectives, the present disclosure adopts the following technical solutions:

A reserve optimization method based on a support outage event constrained unit commitment, including the following steps:

step 1: running a basic unit commitment model to obtain a basic unit commitment dispatch result;

step 2: establishing a committed capacity outage probability table (CCOPT) based on the obtained dispatch result, calculating the LOLP, and seeking marginal events based on the CCOPT; and

step 3: adding linear constraints corresponding to the marginal events to the reserve optimization model to obtain a new dispatch result, and returning to step 2 till the result meets the LOLP requirements.

Further, the basic unit commitment model in step 1 is a model that does not include the LOLP constraint.

Further, the rows of the CCOPT represent outage events that may occur to units, and the columns of the CCOPT represent the outage capacity, the individual outage probability, and the cumulative outage probability.

Further, the LOLP is expressed as:

$${LOLP}^{t} = {\sum }_{i = 1}^{n} {p}_{i , t} {b}_{i , t}$$

where n is the number of the rows of CCOPT, indicating the number of the outage events that may occur to the units during period t; p_{i,t} represents the individual outage probability that event i occurs; b_{i,t} is a 0/1 variable to represent whether a corresponding outage scenario has a load shedding during period t, b_{i,t}=1 indicates that some load will lose in the scenario, and b_{i,t}=0 indicates that no load will lose in the scenario.

Further,

$${b}_{i , t} = \{ \begin{matrix}1 , if Δ {CC}_{i , t} - S S {R}_{t} > 0 \\ 0 , if Δ {CC}_{i , t} - S S {R}_{t} \leq 0\end{matrix}$$

where ΔCC_{i,t} is the outage capacity of the outage event i during period t, indicating the sum of the power and reserve of all outage units in the event; SSRₜ is the total system spinning reserve during period t.

Further, the marginal events satisfy the marginal constraints:

ΔCC_{s,t}−SSRₜ≤0 s∈Ω⊂Ω*

where ΔCC_{s,t} is the outage capacity of the outage event s during period t, indicating the sum of the power and reserve of all outage units in the event; SSRₜ is the total system spinning reserve during period t, Ω* indicates an outage event that does not cause loss of load, and s indicates a marginal event.

Further, the method for identifying the marginal events is:

identifying the (i−1) row and the i row in the CCOPT. The corresponding cumulative probability satisfying: the sum of the outage probability of scenarios of row i and below rows in CCOPT does not exceed the LOLP^{max}, but the sum of probability of scenarios of row (i−1) and below rows does exceed LOLP^{max};

wherein the scenario corresponds to the (i−1) is a marginal scenario, and the same type outage scenarios are also seen as marginal scenarios.

According to the second objective of the present disclosure, the present disclosure also discloses a reserve optimization apparatus based on a support outage event constrained unit commitment, including a memory, a processor, and a computer program stored in the memory and executable on the processor, wherein the processor executes:

step 1: running a basic unit commitment model to obtain a basic dispatch result;

step 2: establishing a CCOPT based on the dispatch result, calculating the LOLP, and identifying the marginal events; and

step 3: adding linear constraints corresponding to the marginal events to the reserve optimization model to obtain a new dispatch result, and returning to step 2 till the result meets the LOLP requirements.

According to a third objective of the present disclosure, the present disclosure also discloses a computer-readable storage medium storing a computer program thereon, wherein when the program is executed by a processor, the following steps are executed:

step 1: running a basic unit commitment model to obtain a basic unit commitment dispatch result;

step 2: establishing a CCOPT based on the dispatch result, calculating an LOLP, and seeking the marginal events based on CCOPT; and

step 3: adding linear constraints corresponding to the marginal events to the reserve optimization model to obtain a new dispatch result, and returning to step 2 till the result meets the LOLP requirements.

### Beneficial Effects of the Present Disclosure

1. The LOLP constrained reserve optimization model in the present disclosure transforms a highly non-linear and combinatorial LOLP constraint into a series of linear expressions equivalently. Since most of the equivalent linear constraints are loose constraints, only the constraints corresponding to a few key marginal scenarios, that is, marginal contingencies, need to be identified, and the reserve optimization efficiency can be improved only based on the representative scenario constraints.

2. The present disclosure proposes a constraint addition method to solve a representative scenario constrained UC model. Specifically, marginal scenarios are successively identified during iteration based on CCOPT and used as constraints for optimization, till the result meets the LOLP constraint. Multiple compromises in the problem are considered, and the LOLP constraint is simplified such that the model can be solved accurately and efficiently.

3. The optimization method of the present disclosure has high accuracy and validity in single-period and multi-unit multi-period systems.

### BRIEF DESCRIPTION OF THE DRAWINGS

The accompanying drawings constituting a part of the present disclosure are used for providing a further understanding of the present disclosure, and the schematic embodiments of the present disclosure and the descriptions thereof are used for interpreting the present disclosure, rather than constituting improper limitations to the present disclosure.

FIG. 1 is a flowchart of a reserve optimization method based on a support outage event constrained unit commitment according to the present disclosure;

FIG. 2 shows reserves under different reliability levels;

FIG. 3 shows reserves obtained by optimization of systems with different sizes;

FIG. 4 shows comparison of time for systems with different sizes.

### DETAILED DESCRIPTION OF EMBODIMENTS

It should be pointed out that the following detailed descriptions are all exemplary and aim to further illustrate the present disclosure. Unless otherwise specified, all technological and scientific terms used herein have the same meanings generally understood by those of ordinary skill in the art of the present disclosure.

It should be noted that the terms used herein are merely for describing specific embodiments, but are not intended to limit exemplary embodiments according to the present disclosure. As used herein, unless otherwise specified, the singular form is also intended to include the plural form. In addition, it should also be understood that when the terms “include” and/or “comprise” are used in the description, they indicate that, there are features, steps, operations, devices, components and/or their combination.

The embodiments in the present disclosure and the features in the embodiments may be combined with each other in the case of without conflicts.

General idea proposed by the present disclosure:

By analyzing the own characteristics of the LOLP constraint, the LOLP constraint is equivalently expressed as a series of linear constraints, and most of the equivalent linear constraints are loose constraints, so only a small amount of tight constraints are considered. The constraints are gradually added herein by means of iteration. Starting from a basic unit commitment problem, a CCOPT is established based on the dispatch result, and the marginal events are identified therefrom. The linear constraints corresponding to the marginal events are added to the reserve optimization model of the next iteration. As the iteration progresses, constraints are continuously added till the result meets the LOLP requirements. The constraint addition method proposed herein is used to solve the reserve optimization problem with an LOLP constraint, and considers multiple compromises in the problem, and simplifies the LOLP constraint such that the model can be accurately and efficiently solved.

LOLP Constrained Spinning Reserve Optimization Model (LCUC)

The objective function in the LOLP constrained spinning reserve optimization model is the sum of operating cost and reserve cost:

$$min \{ {\sum }_{t = 1}^{{N}_{T}} {\sum }_{i = 1}^{{N}_{C}} [ {C}_{i , t} ( {P}_{i , t} , {U}_{i , t} ) + {SUC}_{i} {K}_{i , t} ] + {\sum }_{t = 1}^{{N}_{T}} {\sum }_{i = 1}^{{N}_{G}} {q}_{i , t} , {R}_{i , t} \} \qquad ( 1 )$$

Where N_{T} is the total number of optimization periods; N_{G} is the number of generators that can be dispatched; U_{i,t} is the on/off status of unit i during period t; P_{i,t} is the output power of unit i during period t; q_{i,t} is the reserve price of unit i during period t; b_{i,t} is the reserve provided by unit i during period t; Cᵢₜ(Pᵢₜ,Uᵢₜ) is the operating cost of unit i during period t, and is expressed by a three-segment linear function; SUCᵢ is the start up cost of unit i; K_{i,t} is a 0/1 variable, it satisfying

$$\{ \begin{matrix}{K}_{i , t} \geq 0 \\ {K}_{i , t} \geq {U}_{i , t} - {U}_{i , t - 1}\end{matrix} \qquad ( 2 )$$

The objective function should satisfy the following constraints:

1) Power Balance Constraint

$${\sum }_{i = 1}^{{N}_{G}} {P}_{i , t} = {P}_{t}^{D} \qquad ( 3 )$$

Here Pₜ^{D} is the load at time t.

2) Spinning Reserve Constraint

$$\{ \begin{matrix}{R}_{i , t} \leq {P}_{i ,}^{max} {U}_{i , t} - {P}_{i , t} \\ {R}_{i , t} \leq {U}_{i , t} ( τ {UR}_{i} )\end{matrix} \qquad ( 4 )$$

Here Pᵢ^{max} is the maximum output of the unit i; URᵢ is the ramp up rate of unit i; τ is the time for the unit to release its reserve; τ is set to 0.5 h here.

3) Unit Operation Constraint

(P_{i,t},U_{i,t})∈ψ,∀i,∀t (5)

The constraint of the above expression usually includes upper and lower limit constraints of the unit output power, minimum up/down time constraints, initial condition constraints, and ramp rate constraints. They are general constraints in unit commitment model. For simplicity, they are not explicitly shown here.

4) System Reliability Constraint, that is, the LOLP Value of the System should be Smaller than a Given Value.

LOLP<LOLP^{max} (6)

Here, only unit outage events are considered. Therefore, the outage events can be divided into first-order, second-order, and third-order events according to the number of the simultaneous outage of units. For the sake of brevity, the following expression only considering the first-order and the second order outage events of LOLP:

$$LOLP \approx {\sum }_{i = 1}^{{N}_{G}} {p}_{i , t} {b}_{i , t} + {\sum }_{i = 1}^{{N}_{G}} {\sum }_{j > t}^{{N}_{G}} {p}_{i , j , t} {b}_{i , j , t} \qquad ( 7 )$$

Where p_{i,t} is the outage probability of unit i during period t; p_{i,j,t} is the probability of simultaneous outage of units i and j during period t.

The binary variables b_{i,t} and k_{i,t} satisfy:

$$\begin{matrix}{b}_{i , t} = \{ \begin{matrix}1 , & if {P}_{i , t} + {R}_{i , t} - {SSR}_{t} > 0 \\ 0 , & if {P}_{i , t} + {R}_{i , t} - {SSR}_{t} \leq 0\end{matrix} & ( 8 ) \\ {b}_{i , t} = \{ \begin{matrix}1 , & if {P}_{i , t} + {R}_{i , t} + {P}_{j , t} + {R}_{j , t} - {SSR}_{t} > 0 \\ 0 , & if {P}_{i , t} + {R}_{i , t} + {P}_{j , t} + {R}_{j , t} - {SSR}_{t} \leq 0\end{matrix} & ( 9 )\end{matrix}$$

Here SSRₜ is the total system reserve at time t, satisfying:

$${SSR}_{t} = {\sum }_{i = 1}^{{N}_{G}} {R}_{i , t} \qquad ( 10 )$$

Equations (8) and (9) can be linearized. For example, equation (8) may be equivalently linearized as:

$$\frac{{P}_{i , t} + {R}_{i , t} - {SSR}_{t}}{{\sum }_{i = 1}^{{N}_{G}} {P}_{i ,}^{max}} \leq {b}_{i , t} \leq 1 + \frac{{P}_{i , t} + {R}_{i , t} - {SSR}_{t}}{{\sum }_{i = 1}^{{N}_{G}} {P}_{i ,}^{max}} \qquad ( 11 )$$

The outage probabilities p_{i,t} and p_{i,j,t} can be expressed as:

$$\begin{matrix}{p}_{i , t} = {u}_{i} {U}_{i , t} {\prod }_{j = 1 , j \neq i}^{{N}_{G}} ( 1 - {u}_{j} {U}_{j , t} ) & ( 12 ) \\ {p}_{i , j , t} = {u}_{i} {u}_{j} {U}_{i , t} {U}_{j , t} {\prod }_{k = 1 , k \neq i , j}^{{N}_{G}} ( 1 - {u}_{k} {U}_{k , t} ) & ( 13 )\end{matrix}$$

Where uᵢ is the outage replacement rate and it is equal to rᵢΔT during period ΔT, and rᵢ is the outage rate of the unit i. Here ΔT is 1 h.

This embodiment discloses reserve optimization method based on a support outage event constrained unit commitment, including the following steps:

step 1: running a basic unit commitment reserve optimization model to obtain a basic unit commitment dispatch result;

step 2: establishing a CCOPT based on the dispatch result, calculating the LOLP, and identify the marginal events based on CCOPT; and

step 3: adding linear constraints corresponding to the marginal events to the reserve optimization model to obtain a new dispatch result, then returning to step 2 till the result meets the LOLP requirements.

As for the basic unit commitment reserve optimization model in step 1, the objective function is shown in equation (1), and the constraints are shown in (2) to (5).

The CCOPT in step 2 includes outage capacity, individual outage probability, and cumulative probability.

Specifically, the CCOPT is established according to the obtained dispatch result, as shown in Table 1.

TABLE 1
Committed capacity outage probability table

| Outage | Outage | Cumulative |
|---|---|---|
| capacity | probability | probability |
| 0 | p_{1,t} | 1 |
| ΔCC_{2,t} | p_{2,t} | 1 − p_{1,t} |
| ΔCC_{3,t} | p_{3,t} | 1 − p_{1,t} − p_{2,t} |
| . . . | . . . | . . . |
| ΔCC_{n,t} | p_{n,t} | $1 - {\sum }_{i = 1}^{n - 1} {p}_{i , t}$ |

The LOLP may be calculated from the CCOPT, and the LOLP is expressed as:

$${LOLP}^{t} = {\sum }_{i = 1}^{n} {p}_{i , t} {b}_{i , t} \qquad ( 14 )$$

Where n is the number of the rows of CCOPT, indicating the number of the outage events that may occur to the units during period t; p_{i,t} represents the outage probability that event i occurs, and it can be known from equations (12-13). p_{i,t} in CCOPT is always larger than 0; b_{i,t} is a 0/1 variable to represent whether a corresponding outage cause loss of load during period t, b_{i,t}=1 indicates loss of load will occur in the event of the scenario, and b_{i,t}=0 indicates no load will lose in the event of the scenario.

b_{i,t} can be expressed as:

$${b}_{i , t} = \{ \begin{matrix}1 , & if {ΔCC}_{i , t} - {SSR}_{t} > 0 \\ 0 , & if {ΔCC}_{i , t} - {SSR}_{t} \leq 0\end{matrix} \qquad ( 15 )$$

where ΔCC_{i,t} is the outage capacity of outage event i during period t, indicating the sum of the power and reserve of the outage units in the event. For example, if the event i indicates that unit x and y simultaneously fail, then ΔCC_{i,t}=Pₓ+Rₓ+P_{y}+R_{y}; SSRₜ is the total system spinning reserve during period t.

For LOLP constrained reserve optimization problem, if the optimal solution is obtained, a reserve SSRₜ* can be obtained and a CCOPT can be established.

According to equation (15), SSRₜ* divides the outage events into two parts in CCOPT. One part includes outage events that do not cause loss of load, and it constitutes the set Ω* ; and the other part includes outage events that cause loss of load, and it constitutes the set Ω̅*. Ω* and Ω̅* constitute a universal set of outage events that may occur during optimal dispatching of the system, and the sum of their probability is 1. Therefore, the outage capacity of all events that do not cause LOLP and cause LOLP in the optimal solution satisfies:

$$\{ \begin{matrix}ΔC {C}_{s , t}^{*} - {SSR}_{t}^{*} \leq 0 & s ∈ {Ω}^{*} \\ ΔC {C}_{s , t}^{*} - {SSR}_{t}^{*} > 0 & s ∈ {\overline{Ω}}^{*}\end{matrix} \qquad ( 16 )$$

In equation (16), both ΔCC_{s,t}* and SSRₜ* are parameters, and the events in Ω* and Ω̅* are also determined.

Obviously, the optimal solution cannot be known in advance, but if the events in Ω* and Ω̅* can be determined, it can be known in advance which events cause LOLP and which events do not cause LOLP. Equation (16) may be transformed into:

$$\{ \begin{matrix}{ΔCC}_{s , t} - {SSR}_{t} \leq 0 & s ∈ {Ω}^{*} \\ {ΔCC}_{s , t} - {SSR}_{t} > 0 & s ∈ {\overline{Ω}}^{*}\end{matrix} \qquad ( 17 )$$

In equation (17), the events in Ω* and are determined, but both ΔCC_{s,t} and SSRₜ are variables. If the original LOLP constraint equation (7) is replaced by equation (17) introduced above, the optimal solution can be obtained after optimization.

Further, if only the events in Ω* are known in advance, equation (17) is transformed into:

ΔCC_{s,t}−SSRₜ≤0 s∈Ω* (18)

Due to the complementarity of Ω* and Ω̅*, the sum of outage probabilities of Ω* and Ω̅* is 1, so if the original LOLP constraint equation (7) is substituted by equation (18), and the optimal dispatching result can also be obtained after optimization. However, the events in Ω* cannot be known in advance, so it is neither realistic nor feasible to enumerate all the constraints in equation (18).

Further, a large number of constraints in equation (18) are loose. For example, the outage capacity of many events in the optimal solution is significantly smaller than the system reserve, and the constraints in equation (18) corresponding to these events are loose. That is, most of the events in Ω* are loose, and can be covered by a few events in Ω*. Therefore, only a few key events in Ω* need to be found out to constitute a new constraint equation (19), and the optimal solution can also be obtained after optimization. Now the key to deal with the LOLP constrained reserve optimization problem is how to identify the support events in Ω* . The identification of the support events is based on the CCOPT. In the CCOPT which is established based on the optimal solution, the outage capacity of these support events is near SSRₜ*, where the few support events may be referred to as marginal events, and the corresponding constraints are referred to as marginal constraints.

ΔCC_{s,t}−SSRₜ≤0 s∈Ω⊂Ω* (19)

Equivalent transforming LOLP constraint from (7) to (19) has the following advantages:

1) The original LOLP constraint of (7) focuses on all outage events, and controls the sum of probabilities of outage event that cause LOLP to be smaller than LOLP^{max}. After the equivalent transformation, the focus shifts to the events that do not cause LOLP, only a small amount of marginal events in the upper part of CCOPT need to be concerned, and a large amount of events in the lower part are not considered, thereby avoids the problem of probability truncating which is usually used in establishing the capacity outage probability table or CCOPT.

2) The outage probability is not explicitly considered in equation (19), and the effect of outage probability is indirectly reflected in the process of identifying the support or marginal events in Ω* .

3) The high-order nonlinear LOLP constraint is transformed into a series of linear constraints. At the same time, the combinatorial characteristics in the LOLP constraint is eliminated, and only a few marginal events need to be considered, so the calculation efficiency is greatly improved.

The method for identifying marginal events in step 2 is:

How to find the marginal scenario constraints in each iteration is the key problem. Marginal scenarios are gradually identified herein according to the given LOLP^{max} and the outage probability in CCOPT.

1) After each iteration, a CCOPT is established based on the obtained dispatch result.

2) The (i−1)-th row and the i-th row are found in the CCOPT, and the cumulative probability satisfies:

$$1 - {\sum }_{i = 1}^{i - 1} {p}_{i , t} \leq L O L {P}^{max} < 1 - {\sum }_{i = 1}^{i - 2} {p}_{i , t} \qquad ( 20 )$$

The significance of the above equation is that, the sum of the outage probability caused by the outage scenarios on the 1-1 row and below in the CCOPT does not exceed LOLP^{max}. But if the probability of outage scenarios on the (i−1) row is added, the sum of the outage probability is just greater than LOLP^{max}. For the current dispatch result, the i row is the boundary where the system is not allowed to cause LOLP, it reflects the minimum external reserve requirement of the system to meet the reliability requirements.

3) The scenario on the (i−1) row in the CCOPT is seen as the marginal scenario. If above the (i−1) row in the CCOPT, the same type of scenarios existing, they are also seen as marginal scenarios. Two scenarios are called same type of scenarios, if the outage units which constitute the scenarios possess the same nominal capacity and outage probability.

As another preferred embodiment of the present disclosure, the present disclosure also provides a reserve optimization apparatus based on a support outage event constrained unit commitment, including a memory, a processor, and a computer program stored in the memory and executable on the processor, wherein the processor executes:

step 1: running a basic unit commitment reserve optimization model to obtain a basic unit commitment dispatch result;

step 2: establishing a CCOPT based on the dispatch result, calculating the LOLP, and identify the marginal events therefrom; and

step 3: adding linear constraints corresponding to the marginal events to the reserve optimization model to obtain a new dispatch result, and returning to step 2 till the result meets the LOLP requirements.

As another preferred embodiment of the present disclosure, the present disclosure also provides a computer-readable storage medium storing a computer program thereon, wherein when the program is executed by a processor, the following steps are executed:

step 1: running a basic unit commitment reserve optimization model to obtain a basic unit commitment dispatch result;

step 2: establishing a CCOPT based on the dispatch result, calculating the LOLP, and identify the marginal events therefrom; and

step 3: adding linear constraints corresponding to the marginal events to the reserve optimization model to obtain a new dispatch result, and returning to step 2 till the result meets the LOLP requirements.

Each step involved in the above two apparatuses corresponds to the method embodiment, and the specific implementation may be referred to the related description of Embodiment 1. The term “computer-readable storage medium” should be understood as a single medium or multiple media including one or more instruction sets, and should also be understood to include any medium capable of storing, coding or bearing an instruction set executable by a processor and causing the processor to perform any of the methods of the present disclosure.

In order that those skilled in the art can understand the technical solution of the present disclosure more clearly, the technical solution of the present disclosure will be described in detail below in combination with a specific embodiment.

### Embodiment 1

The IEEE-RTS system is taken as an example to verify the validity of the proposed method herein. The system contains 26 units. The unit commitment data and the rampuprate limit are obtained from the prior art, and the start up cost and reliability data of the generator units are obtained from the prior art. For simplicity, the reserve price is equal to 10% of the maximum incremental cost of power generation. The output of the units at the initial condition is determined by the economic dispatch when the load is 1700 MW in the first period. For simplicity, first we only considering one period. When the LOLP^{max} is 0.001, the proposed method is used to solve the LOLP constrained reserve optimization problem.

A basic unit commitment that does not consider spinning reserve is run. The status and output of each generator are shown in Table 2. Based on these results, a CCOPT is established which is shown in Table 3. The probabilities of third-order or higher-order outage events are very small, and they can be ignored.

TABLE 2
dispatch result of basic unit commitment

| Unit number | P/MW | R/MW |
|---|---|---|
| 17 | 155.00 | 0 |
| 18 | 152.16 | 0 |
| 19 | 121.42 | 0 |
| 20 | 121.42 | 0 |
| 24 | 350.00 | 0 |
| 25 | 400.00 | 0 |
| 26 | 400.00 | 0 |

Table 3
CCOPT established based on dispatch result of basic UC

| | | Outage | | |
|---|---|---|---|---|
| | | capacity | Outage | Cumulative |
| Scenarios | Unit | (MW) | probability | probability |
| 1 | — | 0 | 0.99316902 | 1 |
| 2 | 20 | 121.42 | 0.00103509 | 0.00683098 |
| 3 | 19 | 121.42 | 0.00103509 | 0.00579589 |
| 4 | 18 | 152.16 | 0.00103509 | 0.0047608 |
| 5 | 17 | 155 | 0.00103509 | 0.00372571 |
| 6 | 19 × 20 | 242.84 | 1.08E-06 | 0.00269062 |
| 7 | 18 × 19 | 273.58 | 1.08E-06 | 0.00268954 |
| 8 | 18 × 20 | 273.58 | 1.08E-06 | 0.00268846 |
| 9 | 17 × 19 | 276.42 | 1.08E-06 | 0.00268738 |
| 10 | 17 × 20 | 276.42 | 1.08E-06 | 0.0026863 |
| 11 | 17 × 18 | 307.16 | 1.08E-06 | 0.00268522 |
| 12 | 24 | 350 | 0.000864 | 0.00268414 |
| 13 | 18 × 19 × 20 | 395 | 1.15E-09 | 0.00182014 |
| 14 | 17 × 19 × 20 | 397.84 | 1.15E-09 | 0.00182014 |
| 15 | 25 | 400 | 0.000903292 | 0.00182014 |
| 16 | 26 | 400 | 0.000903292 | 0.00091685 |
| 17 | 17 × 18 × 19 | 428.58 | 1.15E-09 | 1.36E-05 |
| 18 | 17 × 18 × 20 | 428.58 | 1.15E-09 | 1.36E-05 |
| 19 | 24 × 19 | 471.42 | 9.00E-07 | 1.36E-05 |
| 20 | 24 × 20 | 471.42 | 9.00E-07 | 1.27E-05 |
| 21 | 24 × 18 | 502.16 | 9.00E-07 | 1.18E-05 |
| 22 | 24 × 17 | 505 | 9.00E-07 | 1.09E-05 |

A marginal commitment is identified according to the method of the present disclosure. The LOLP^{max} is 0.001. From Table 3 it can be found that the cumulative probability of the 15^{th} row in the CCOPT is 0.00182014, and the cumulative probability of the 16^{th} row is 0.000916849. Since 0.000916849<0.001<0.00182014, so the outage of the 25^{th} generator in the 15^{th} row constitute a marginal scenario.

After the marginal scenarios are found, a set Ω of marginal scenarios is constituted. At this time, the LOLP constraint may be simplified as

$${\sum }_{k ∈ Ω} {P}_{k} + {R}_{k} - {SSR}_{t} \leq 0 \qquad ( 26 )$$

Here the outage scenario included in Ω is the outage of the 25^{th} unit.

Therefore, k corresponds to the 25^{th} generator.

The system spinning reserve after optimization is 300 MW, and LOLP^{after}=0.001700>LOLP^{max}, which does not satisfy the stopping criterion. So more iteration is needed. The new CCOPT is established based on new obtained optimization results, and new marginal scenarios will be identified. In the second iteration, it is found that the marginal scenario is the outage of the 24^{th} unit, and the marginal scenario is added to the set Ω, the constraint equation similar as equation (18) is established. The reserve after optimization is 333.50 MW, and LOLP^{after}=0.00093575<LOLP^{max}, which satisfies the stopping criterion. The entire optimization stops.

In view of the optimization process, as the iteration progresses, the reserve is gradually increased. As the marginal scenarios are gradually added to the set, the corresponding constraints increase, which improves the requirements for the system reserve. In addition, the system reserve is always equal to the outage capacity of the newly added marginal scenario after each iterative optimization. The process of reserve growth is also a process of economy decline and reliability improvement, and finally meets the reliability requirements.

Validity and Accuracy of the Method

Taking the IEEE-RTS 26-unit system as an example. When the LOLP^{max} varies, the corresponding costs are calculated. In order to show the performance of the method proposed in present disclosure, the original LOLP constrained unit commitment model is used as the benchmark. The results are shown in Table 4.

TABLE 4
Cost comparison of three methods under different LOLP^{max}

| | Original | Cost of method in |
|---|---|---|
| LOLP^{max} | model cost/$ | present disclosure/$ |
| 0.006 000 | 185 80.77 | 185 80.77 |
| 0.004 000 | 186 77.05 | 186 77.05 |
| 0.002 000 | 193 91.51 | 193 91.51 |
| 0.001 000 | 208 03.63 | 208 04.83 |
| 0.000 100 | 214 77.41 | 214 77.41 |
| 0.000 010 | 264 67.93 | 264 67.93 |
| 0.000 005 | 293 97.67 | 293 98.52 |
| 0.000 001 | No solution | No solution |

The comparison shows that the results of the method proposed in present disclosure are approximately equal to the results of the original model, which illustrates the validity and accuracy of the method proposed in present disclosure.

Efficiency of the Method

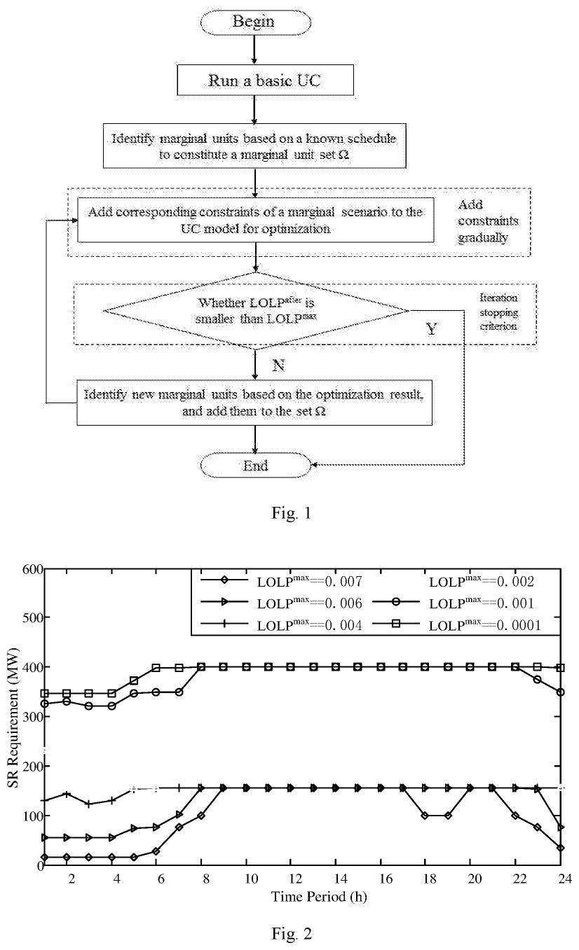

For a multi-unit and multi-period system, the method in present disclosure can be used to solve the problems that cannot be solved by the original model. Also taking the IEEE-RTS system as an example. It has 26 units. The optimization period is 24 hours, and marginal units need to be identified for each period. For different LOLP^{max}, the reserve obtained by the method of present disclosure is shown in FIG. 2. Considering the second-order outage events, the run time of the original model and the method proposed in present disclosure under different LOLP^{max} is shown in Table 5.

TABLE 5
Comparison of time taken for the original model and the
method in present disclosure.

| | Time for the | Time for the method |
|---|---|---|
| LOLP^{max} | original model | in present disclosure |
| 0.007 000 | Out of memory | 65 s |
| 0.006 000 | Out of memory | 35 s |
| 0.004 000 | Out of memory | 23 s |
| 0.002 000 | 16 min 41 s | 42 s |
| 0.001 000 | 16 min 41 s | 33 s |
| 0.0001 | 1 min 51 s | 28 s |
| 0.00001 | No solution | No solution |
| 0.000005 | No solution | No solution |
| 0.000001 | No solution | No solution |

It can be seen from FIG. 2 that the reserve gradually increases with the decrease of the LOLP^{max}. The reserve remains unchanged at some moments, and at this time, the system has certain anti-interference ability and can be used to deal with load fluctuations and uncertainty caused by renewable energy integration. A reasonable operating condition of the system can be determined based on the trade off between economy and reliability considering different LOLP^{max} and corresponding costs. It can be seen from Table 5 that, when the original model is used and the second-order outage events are considered, the computer memory is exhausted under some LOLP^{max}. If higher-order outages are considered, it is more difficult to calculate. This is the calculation bottleneck caused by the LOLP constraint in the original model. With the method proposed in present disclosure, the time is significantly reduced, and the problems that cannot be solved using the original model can be quickly calculated. Besides, it is also found that the time of each iteration in the method of present disclosure is similar to that of the reserve constrained unit commitment (RCUC) model and is related to the number of the iterations. For example, only two iterations are needed when the LOLP^{max} is 0.006 and only one iteration is needed. When the LOLP^{max} is 0.000 5. When the LOLP^{max} is 0.000 5, the reserve after optimization is just equal to the capacity of the largest online units. At this time, the reserve can deal with all first-order outage events, and the optimal solution is easy to find. The calculation time using the original model is also short. Based on the experience of the solution, a few iterations are required till stopping.

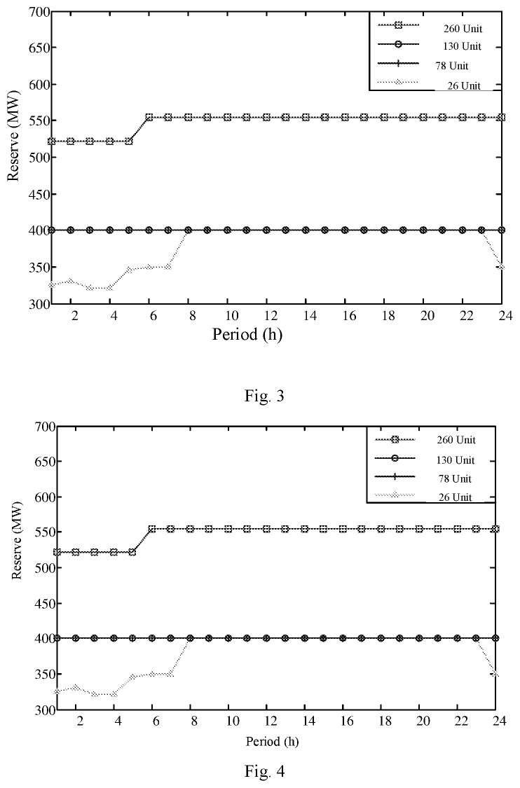

In order to verify the high efficiency of the method for multi-unit system, the IEEE-RTS 26-unit system is duplicated to create large systems with 3, 5 and 10 times the number of the original units, respectively, and the loads are also duplicated accordingly. When LOLP^{max} is 0.001, the results of the systems with different sizes are shown in FIG. 3, and the computation time is shown in FIG. 4.

The model used in present disclosure is coded on The General Algebraic Modeling System(GAMS) platform. The large-scale mixed integer linear programming (MILP) solver CPLEX is used to solve the proposed model with Visual C. The duality gap of MILP is 0.1%. The CPU of the computer used is 3.6 GHz, and the operating memory is 4 G.

### Beneficial Effects of the Present Disclosure

1. The LOLP constrained reserve optimization model in the present disclosure transforms a highly non-linear and combinatorial LOLP constraint into a series of linear expressions equivalently. Since most of linear constraints are loose constraints, only the constraints corresponding to a few key marginal scenarios, that is, the marginal contingencies, need to be identified, and the reserve optimization efficiency can be significantly improved only based on the representative scenario constraints.

2. The present disclosure proposes a constraint addition method to solve are presentative scenario-constrained UC model. Specifically, marginal scenarios are successively identified by iteration in combination with CCOPT and used as constraints for optimization, till the result meets the LOLP constraint. Multiple compromises in the problem are considered, and the LOLP constraint is simplified such that the model can be accurately and efficiently solved.

3. The optimization method of the present disclosure possesses high accuracy and validity in single-period and multi-unit multi-period systems.

It should be appreciated by those skilled in the art that the modules or steps of the present disclosure can be implemented by a general computing apparatus. Alternatively, the modules or steps can be implemented by program codes executable by the computing apparatus. Accordingly, the modules or steps can be stored in a storage apparatus and executed by the computing apparatus or fabricated into individual integrated circuit modules respectively, or a plurality of modules or steps of them are fabricated into a single integrated circuit module. The present disclosure is not limited to any particular combination of hardware and software.

Although the specific embodiments of the present disclosure are described above in combination with the accompanying drawings, the protection scope of the present disclosure is not limited thereto. It should be understood by those skilled in the art that various modifications or variations could be made by those skilled in the art based on the technical solution of the present disclosure without any creative effort, and these modifications or variations shall fall into the protection scope of the present disclosure.

1. A reserve optimization method based on a support outage event constrained unit commitment, the method comprising:
step 1: running a basic unit commitment reserve optimization model to obtain a basic unit commitment dispatch result;
step 2: establishing a committed capacity outage probability table (CCOPT) based on the dispatch result, calculating the loss of load probability (LOLP), and identifying marginal events based on CCOPT; and
step 3: adding linear constraints corresponding to the marginal events to the reserve optimization model to obtain a new dispatch result, and returning to step 2 till the result meets requirements of the LOLP.

2. The reserve optimization method based on a support outage event constrained unit commitment according to claim 1, wherein the basic unit commitment reserve optimization model in step 1 is a spinning reserve optimization model that does not consider LOLP constraint.

3. The reserve optimization method based on a support outage event constrained unit commitment according to claim 1, wherein rows of the CCOPT represent outage events that may occur to units, and columns of the CCOPT represent an outage capacity, individual outage probability, and cumulative outage probability.

4. The reserve optimization method based on a support outage event constrained unit commitment according to claim 3, wherein the LOLP is expressed as:
$${LOLP}^{t} = {\sum }_{i = 1}^{n} {p}_{i , t} {b}_{i , t}$$
in which, n is the number of the rows of CCOPT, indicating the number of the outage events that may occur to units during period t; p_{i,t} represents a outage probability that the event i occurs; b_{i,t} is a 0/1 variable for determining whether a corresponding outage scenario has a lost load during period t, b_{i,t}=1 indicates that a lost load may occur in the scenario, and b_{i,t}=0 indicates that no lost load may occur in the scenario.

5. The reserve optimization method based on a support outage event constrained unit commitment according to claim 4, wherein:
$${b}_{i , t} = \{ \begin{matrix}1 , & if Δ {CC}_{i , t} - {SSR}_{t} > 0 \\ 0 , & if Δ {CC}_{i , t} - {SSR}_{t} \leq 0\end{matrix}$$
in which ΔCC_{i,t} is the outage capacity of event i during period t, indicating the sum of the power and reserve of all outage units in the event; SSRₜ is the total system spinning reserve during period t.

6. The reserve optimization method based on a support outage event constrained unit commitment according to claim 5, wherein the marginal events satisfy marginal constraints:
ΔCC_{s,t}−SSRₜ≤0 s∈Ω⊂Ω*
in which ΔCC_{i,t} is the outage capacity of the outage event i during period t, indicating the sum of the power and reserve of all outage units in the event; SSRₜ is the total system spinning reserve during period t, Ω* indicates an outage event that does not cause loss of load, and s indicates a marginal event.

7. The reserve optimization method based on a support outage event constrained unit commitment according to claim 5, wherein a method for identifying the marginal events is:
identifying the (i−1) row and the i row in the CCOPT, the cumulative probability satisfying: the sum of the outage probability of scenarios of row i and below rows in CCOPT does not exceed the LOLP^{max}, but the sum of probability of scenarios of row (i−1) and below rows does exceed LOLP^{max};
wherein the scenario on the (i−1) row is a marginal scenario, and the same type of outage scenarios as the marginal scenario are also seen as marginal scenarios.

8. A reserve optimization apparatus based on a support outage event constrained unit commitment, comprising a memory, a processor, and a computer program stored in the memory and executable on the processor, wherein the processor performs the method according to claim 1.

9. A computer-readable storage medium storing a computer program thereon, wherein when the program is executed by a processor, the reserve optimization method based on a support outage event constrained unit commitment according to claim 1 is performed.
